(19) United States
(12) Patent Application Publication
(10) Pub. No.: US 2023/0185534 A1
(43) Pub. Date: Jun. 15, 2023

(54) ARITHMETIC PROCESSING DEVICE AND ARITHMETIC PROCESSING METHOD

(71) Applicant: Fujitsu Limited, Kawasaki-shi (JP)

(72) Inventor: Sota Sakashita, Kawasaki (JP)

(73) Assignee: Fujitsu Limited, Kawasaki-shi (JP)

(21) Appl. No.: 17/898,722

(22) Filed: Aug. 30, 2022

(30) Foreign Application Priority Data
Dec. 15, 2021 (JP) 2021-203159

(51) Int. Cl. G06F 7/57

(52) U.S. Cl. CPC G06F 7/57

(57) ABSTRACT

An arithmetic processing device includes, an arithmetic circuit capable of operating as a plurality of sub arithmetic circuits according to a bit width of data to be calculated, and a plurality of registers each including a plurality of subregions that corresponds to the plurality of sub arithmetic circuits respectively. The device further includes a mask circuit that masks, when an operation that uses a part of the plurality of sub arithmetic circuits is executed, storage of invalid operation result data output from the sub arithmetic circuit that does not receive data to be subject to the operation in the subregion; and a data replacement circuit that replaces data, output from the subregion in which the storage is masked, with a zero-value to output the zero-value to the arithmetic circuit when the operation that uses the data retained in the register that includes the subregion in which the storage is masked.

### CROSS-REFERENCE TO RELATED APPLICATION

This application is based upon and claims the benefit of priority of the prior Japanese Patent Application No. 2021-203159, filed on Dec. 15, 2021, the entire contents of which are incorporated herein by reference.

### FIELD

The embodiments discussed herein are related to an arithmetic processing device and an arithmetic processing method.

### BACKGROUND

There has been known an arithmetic processing device capable of executing vector-friendly instructions of different data types, supporting merging-write masking and nulling-write masking, and having register renaming function.

Japanese Laid-open Patent Publication No. 2017-79078 is disclosed as related art.

### SUMMARY

According to an aspect of the embodiments, an arithmetic processing device including an arithmetic circuit capable of operating as a plurality of sub arithmetic circuits according to a bit width of data to be calculated; a plurality of registers each of which includes a plurality of subregions that corresponds to the plurality of sub arithmetic circuits, respectively; a mask circuit that masks, when an operation that uses a part of the plurality of sub arithmetic circuits is executed, storage of invalid operation result data output from the sub arithmetic circuit that does not receive data to be subject to the operation in the subregion; and a data replacement circuit that replaces data, output from the subregion in which the storage is masked, with a zero-value to output the zero-value to the arithmetic circuit when the operation that uses the data retained in the register that includes the subregion in which the storage is masked.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an exemplary arithmetic processing device according to an embodiment;

FIG. 2 is an explanatory diagram illustrating exemplary operation of the arithmetic processing device of FIG. 1;

FIG. 3 is a block diagram illustrating an exemplary arithmetic processing device according to another embodiment;

FIG. 4 is a block diagram illustrating an exemplary FPR renaming table in FIG. 3;

FIG. 5 is a block diagram illustrating an exemplary method of setting a physical register number to be stored in the FPR renaming table in FIG. 3;

FIG. 6 is a block diagram illustrating an exemplary circuit for executing a load instruction or a store instruction in an operation execution unit in FIG. 3;

FIG. 7 is a block diagram illustrating an exemplary circuit for executing an operation instruction in the operation execution unit in FIG. 3;

FIG. 8 is a block diagram illustrating an exemplary circuit for writing data to an FPR in FIG. 3;

FIG. 9 is an explanatory diagram illustrating an outline of data writing to the FPR in FIG. 3;

FIG. 10 is a block diagram illustrating an exemplary circuit for reading data from the FPR in FIG. 3;

FIG. 11 is a timing diagram illustrating exemplary operation of reading data from the FPR with the circuit illustrated in FIG. 10;

FIG. 12 is a block diagram illustrating an exemplary arithmetic processing device according to another embodiment;

FIG. 13 is an explanatory diagram illustrating an exemplary load instruction to be executed by the arithmetic processing device of FIG. 12;

FIG. 14 is a block diagram illustrating an example of another arithmetic processing device;

FIG. 15 is a block diagram illustrating an exemplary FPR renaming table in FIG. 14;

FIG. 16 is a block diagram illustrating an exemplary circuit for writing data to an FPR in FIG. 14; and

FIG. 17 is a block diagram illustrating an exemplary circuit for reading data from the FPR in FIG. 14.

### DESCRIPTION OF EMBODIMENTS

An instruction set architecture of an arithmetic processing device such as a central processing unit (CPU) may include instructions of various data widths such as 32 bits, 64 bits, and the like. In a case where a second instruction with a wider data width is executed using an operation result of a first instruction with a narrower data width, for example, a zero value is stored in a high-order bit of a register in which the operation result of the instruction with the narrower data width is stored to correctly execute the second instruction.

At the time of the first instruction execution, whether or not the register storing the operation result of the first instruction is used in the second instruction may not be known. Accordingly, the arithmetic processing device writes a zero value in the high-order bit of the register that stores the operation result each time the first instruction is executed. In the case of writing a zero value in the high-order bit of the register, power consumption increases as compared with the case of not writing a zero value.

In one aspect, the embodiments aim to reduce power consumption of an arithmetic processing device by suppressing zero value writing to a high-order bit of a register in which an operation result of an instruction with a small data width is stored.

Hereinafter, embodiments will be described with reference to the drawings.

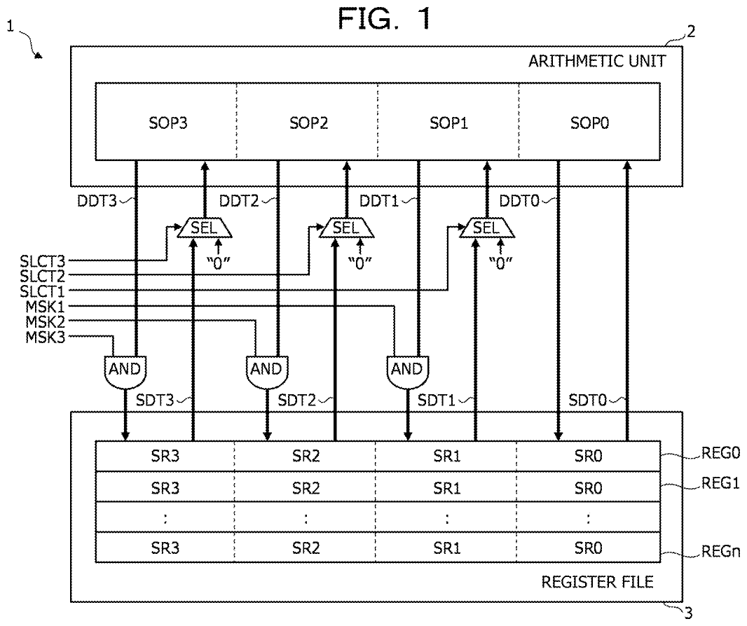

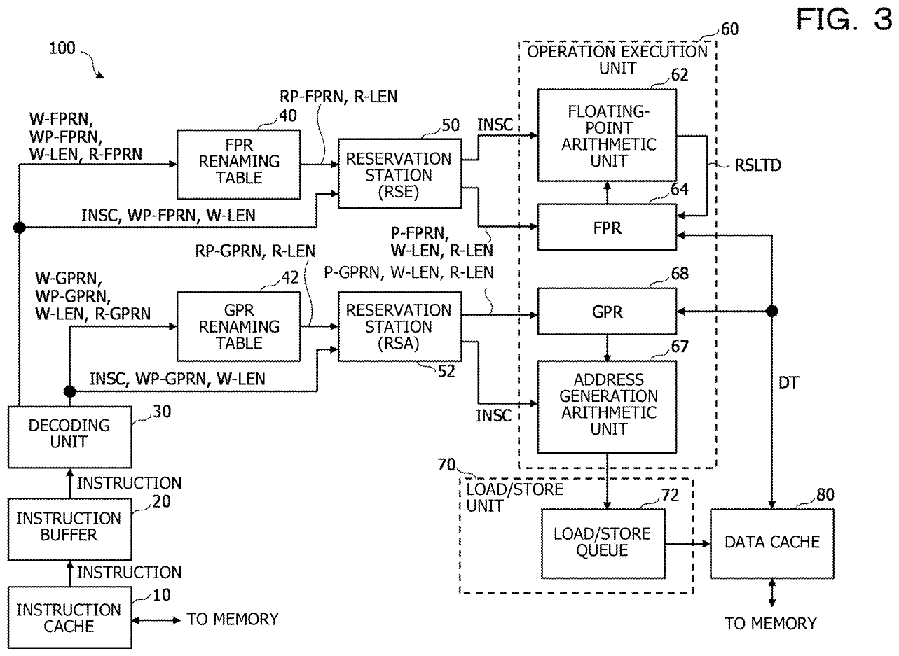

FIG. 1 illustrates an exemplary arithmetic processing device according to an embodiment. An arithmetic processing device 1 illustrated in FIG. 1 is, for example, a processor such as a CPU having a function of executing a plurality of product-sum operations and the like in parallel using a single instruction multiple data (SIMD) operation instruction. Note that the arithmetic processing device 1 may include an instruction cache 10, an instruction buffer 20, a decoding unit 30, an FPR renaming table 40, and a GPR renaming table 42 to be described with reference to FIG. 3. Furthermore, the arithmetic processing device 1 may include reservation stations 50 and 52, an address generation arithmetic unit 67, a load/store unit 70, and a data cache 80 to be described with reference to FIG. 3.

The arithmetic processing device 1 includes an arithmetic unit 2, a register file 3, a plurality of AND circuits AND, and a plurality of selectors SEL. The AND circuits AND are exemplary mask circuits, and the selectors SEL are exemplary data replacement circuits. The arithmetic unit 2 includes a plurality of sub arithmetic units SOP (SOP0 to SOP3) capable of operating according to a bit width of data to be calculated. The register file 3 includes a plurality of registers REG (registers REG0 to REGn; n is an integer of 2 or more) each including a plurality of subregions SR (SR0 to SR3) corresponding to the plurality of sub arithmetic units SOP.

Each of thick signal lines between the arithmetic unit 2 and the register file 3 indicates that multiple bit data are transferred. Then, the arithmetic unit 2 executes operation using at least one data SDT transferred from the register file 3.

Although not particularly limited, hereinafter, it is assumed that the arithmetic unit 2 is capable of executing operation of data of up to 128 bits, and that each of the sub arithmetic units SOP is capable of executing calculation of 32-bit data. In this case, for example, the arithmetic unit 2 is capable of executing a 128-bit operation instruction, a 64-bit operation instruction, a 32-bit operation instruction, two 64-bit SIMD operation instructions, four 32-bit SIMD operation instructions, and the like.

Data DDT (operation result data) output from each sub arithmetic unit SOP is 32 bits, and the data SDT (operand data used for calculation) input to each sub arithmetic unit SOP is 32 bits.

Data DDT1 to DDT3 output from sub arithmetic units SOP1 to SOP3, respectively, are supplied to subregions SR1 to SR3 of the register REG via the AND circuits AND, respectively. In a case where corresponding mask signals MSK (MSK1 to MSK3) indicate a masked state (low level), each AND circuit AND masks the output of the corresponding data DDT to the register REG. In a case where the corresponding mask signals MSK indicate an unmasked state (high level), each AND circuit AND outputs the corresponding data DDT to the register REG.

Data SDT1 to SDT3 output from the subregions SR1 to SR3 of the register REG, respectively, are supplied to the sub arithmetic units SOP1 to SOP3 via the selectors SEL, respectively. In a case where corresponding select signals SLCT (SLCT1 to SLCT3) are at a valid level, each selector SEL outputs the corresponding data SDT to the arithmetic unit 2. In a case where the corresponding select signals SLCT are at an invalid level, each selector SEL outputs a zero value to the arithmetic unit 2 instead of outputting the corresponding data SDT to the arithmetic unit 2.

Note that the AND circuit AND for masking transfer of data DDT0 from the sub arithmetic unit SOP0 to the subregion SR0 and the selector SEL for replacing data SDT0 from the subregion SR0 with a zero value may be provided between the sub arithmetic unit SOP0 and the register file 3.

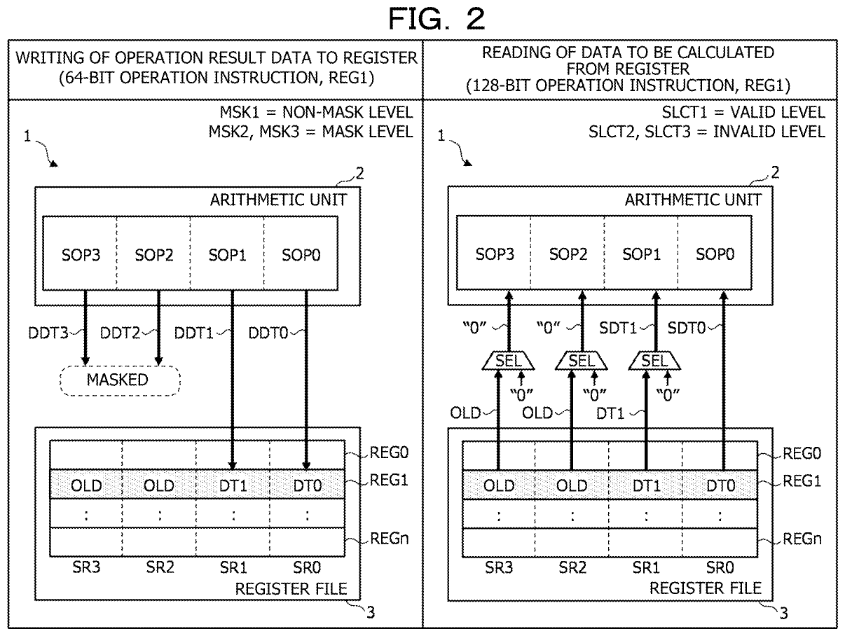

FIG. 2 illustrates exemplary operation of the arithmetic processing device 1 of FIG. 1. In the example illustrated in FIG. 2, the arithmetic unit 2 executes a 64-bit operation instruction to store the 64-bit operation result in a register REGI, and then executes a 128-bit operation instruction using the data retained in the register REGI.

In the case where the arithmetic unit 2 executes the 64-bit operation instruction, the mask signal MSK1 is set to a non-mask level, and the mask signals MSK2 and MSK3 are set to a mask level. In the case where the arithmetic unit 2 executes the 128-bit operation instruction using the register REG retaining the operation result of the 64-bit operation instruction, the select signal SLCT1 is set to the valid level, and the select signals SLCT2 and SLCT3 are set to the invalid level.

In the 64-bit operation instruction, the sub arithmetic units SOP0 and SOP1 execute the operation using valid data to be calculated, and output the operation result as the data DDT0 and DDT1. The sub arithmetic units SOP2 and SOP3 calculate invalid data not to be calculated, and output the operation result as the invalid data DDT2 and DDT3.

The AND circuit AND (FIG. 1) corresponding to the sub arithmetic unit SOP1 receives the mask signal MSK1 at the non-mask level, and outputs the data DDT1 to the register REG. Then, the data DDT0 and DDT1 are stored in the subregions SRO and SRI of the register REG, respectively. The AND circuits AND (FIG. 1) corresponding to the sub arithmetic units SOP2 and SOP3 receive the mask signals MSK2 and MSK3 at the mask level, and mask the output of the invalid data DDT2 and DDT3 to the register REG. As a result, data OLD unrelated to the current operation result is retained in the subregions SR2 and SR3 of the register REG1 without being updated.

For example, in order to correctly execute the subsequent operation instruction retained in the register REG1, the data OLD retained in the subregions SR2 and SR3 is preferably updated to a zero value according to the 64-bit operation result. However, in the present embodiment, writing of the zero value to the subregions SR2 and SR3 is suppressed, whereby power consumed in the subregions SR2 and SR3 for writing the zero value may be reduced.

In the 128-bit operation instruction that uses the data retained in the register REG1 in which the writing of the zero value is suppressed, the arithmetic unit 2 executes the operation using all the sub arithmetic units SOP0 to SOP3. The selector SEL corresponding to the sub arithmetic unit SOP1 receives the select signal SLCT1 at the valid level, and outputs data DT1 read from the subregion SRI of the register REGI to the sub arithmetic unit SOP1. The selectors SEL corresponding to the sub arithmetic units SOP2 and SOP3 receive the select signals SLCT2 and SLCT3 at the invalid level, respectively. Then, the selectors SEL corresponding to the sub arithmetic units SOP2 and SOP3 output zero values to the sub arithmetic units SOP2 and SOP3 instead of the data OLD read from the subregions SR2 and SR3 of the register REG1.

As a result, even in the case where the zero values are not written in the subregions SR2 and SR3 of the register REG at the time of the 64-bit operation instruction, the arithmetic unit 2 is then enabled to correctly execute the 128-bit operation instruction using the data read from the register REG1.

Note that, in a case where the arithmetic unit 2 executes a 32-bit operation instruction, the select signals SLCT1 to SLCT3 are set to the invalid level, and the mask signals MSK1 to MSK3 are set to the mask level. Accordingly, invalid execution result data by the sub arithmetic units SOP1 to SOP3 is not stored in the subregions SR1 to SR3 of the register REG. The data OLD retained in the subregions SR1 to SR3 is maintained without being updated.

Thereafter, it is assumed that the 64-bit operation instruction or the 128-bit operation instruction is executed using the register REG in which the operation result data of the 32-bit operation instruction is stored. Since the select signals SLCT0 to SLCT3 are set to the invalid level, a zero value is output to the sub arithmetic units SOP1 to SOP3 instead of the data OLD read from the subregions SR1 to SR3. As a result, it becomes possible to correctly execute the subsequent operation using the arithmetic unit 2 while reducing the power consumed in the subregions SR1 to SR3 for writing the zero value.

Note that, at the time of executing the 128-bit operation instruction that uses the valid data retained in the register REG, the select signals SLCT1 to SLCT3 are set to the valid level, and the data is transferred from the register REG to each of the sub arithmetic units SOP0 to SOP3 of the arithmetic unit 2. Then, the operation result data DDT0 to DDT3 is stored in the register REG without being masked.

As described above, according to the present embodiment, the arithmetic processing device 1 suppresses the writing of the zero value to the subregions SR of the register REG corresponding to the high-order bit side larger than the data width of the operation instruction. As a result, it becomes possible to reduce the power consumed in the subregions SR for writing the zero value, and to reduce the power consumption of the arithmetic processing device 1. Furthermore, in a case of executing an operation instruction with a large data width using a register in which an operation result of an operation instruction with a small data width is stored, a zero value is supplied to the arithmetic unit 2 instead of the data OLD read from the register REG. As a result, even in a case where the zero value is not written to the high-order bit side in the register REG in which the operation result of the operation instruction with the small data width is stored, the arithmetic unit 2 is then enabled to correctly execute the operation instruction with the large data width. As a result, even in a case of reducing the power consumption by partially suppressing data writing to the register REG, the arithmetic processing device 1 is enabled to execute the operation correctly.

Note that the subregion SR for suppressing the zero-value writing is not limited to the subregion SR on the high-order bit side larger than the data width of the operation instruction, and it is sufficient if it is the subregion SR corresponding to the sub arithmetic unit SOP that does not receive the data to be calculated. Furthermore, the subregion SR for outputting the data to be replaced with the zero value is not limited to the subregion SR on the high-order bit side, and it is sufficient if it is the subregion SR in which the zero-value writing is suppressed.

FIG. 3 illustrates an exemplary arithmetic processing device according to another embodiment. Detailed descriptions of elements similar to the elements described with reference to FIGS. 1 and 2 will be omitted. An arithmetic processing device 100 illustrated in FIG. 3 includes an instruction cache 10, an instruction buffer 20, a decoding unit 30, an FPR renaming table 40, and a GPR renaming table 42. Furthermore, the arithmetic processing device 100 includes a reservation station 50 (reservation station for execution (RSE)), a reservation station 52 (reservation station for address (RSA)), an operation execution unit 60, a load/store unit 70, and a data cache 80. The operation execution unit 60 includes, for example, a floating-point arithmetic unit 62, a physical register 64 (floating point register (FPR)), an address generation arithmetic unit 67, and a physical register 68 (general purpose register (GPR)). Hereinafter, the physical register 64 will also be referred to as an FPR 64, and the physical register 68 will also be referred to as a GPR 68.

The instruction cache 10 retains an instruction transferred from a memory, such as a main memory, and outputs the retained instruction to the instruction buffer 20. For example, the instruction cache 10 may be a primary instruction cache. The instruction buffer 20 accumulates multiple instructions transferred from the instruction cache 10, and sequentially outputs the accumulated instructions to the decoding unit 30 in order.

The decoding unit 30 decodes the instructions received from the instruction buffer 20. When the decoding unit 30 decodes a floating-point operation instruction, it outputs an instruction code INSC, a bit length W-LEN, a physical register number WP-FPRN to be used for the operation, and the like to the FPR renaming table 40 and the reservation station 50. When the decoding unit 30 decodes a memory access instruction, it outputs the instruction code

INSC, the bit length W-LEN, a physical register number WP-GPRN to be used for the operation, and the like to the GPR renaming table 42 and the reservation station 52.

The physical register number WP-FPRN indicates a number of an entry (physical register) of the FPR 64 in which the operation result data is updated, and is represented by 6 bits [5:0]. The physical register number RP-FPRN indicates a number of an entry (physical register) of the FPR 64 that retains the data to be used for the operation, and is represented by 6 bits [5:0]. The physical register number RP-FPRN is output from the FPR renaming table 40 together with a bit length R-LEN indicating the bit width of the data to be used for the operation.

A logical register number W-FPRN indicates a number of a logical register of a destination operand included in the operation instruction and an entry number in the FPR renaming table 40, and is represented by 5 bits [4:0]. A logical register number R-FPRN indicates a number of a logical register of a source operand included in the operation instruction and an entry number in the FPR renaming table 40 for reading the physical register number RP-FPRN and the bit length R-LEN, and is represented by 5 bits [4:0].

The physical register number WP-GPRN, which is represented by 6 bits [5:0], indicates a number of an entry (physical register) of the GPR 68 in which data is updated by a load instruction, and is also written in the GPR renaming table 42. The physical register number RP-GPRN indicates a number of an entry (physical register) of the GPR 68 in which data is read by a store instruction, and is represented by 6 bits [5:0]. The physical register number RP-GPRN is output from the GPR renaming table 42.

A logical register number W-GPRN, which is represented by 5 bits [4:0], indicates a number of a logical register of a destination operand included in a load instruction and an entry number in the GPR renaming table 42, and is read from the GPR renaming table 42. A logical register number R-GPRN indicates a number of a logical register of a source operand included in a store instruction and an entry number in the GPR renaming table 42 for reading the physical register number RP-GPRN and the bit length R-LEN. The logical register number R-GPRN is represented by 5 bits [4:0].

The bit length W-LEN output from the decoding unit 30 is information for specifying the bit width of the data used in the instruction decoded by the decoding unit 30, and is represented by, for example, 1 bit. In the present embodiment, the decoding unit 30 sets the bit length W-LEN to “0” when a 64-bit operation instruction is decoded, and sets the bit length W-LEN to “1” when a 128-bit operation instruction is decoded.

Note that the bit length R-LEN indicates the bit width of the data used for the operation, and is read from the FPR renaming table 40. When the decoding unit 30 decodes the memory access instruction, it may output the bit lengths W-LEN and R-LEN to the GPR renaming table 42, the reservation station 50, and the GPR 68.

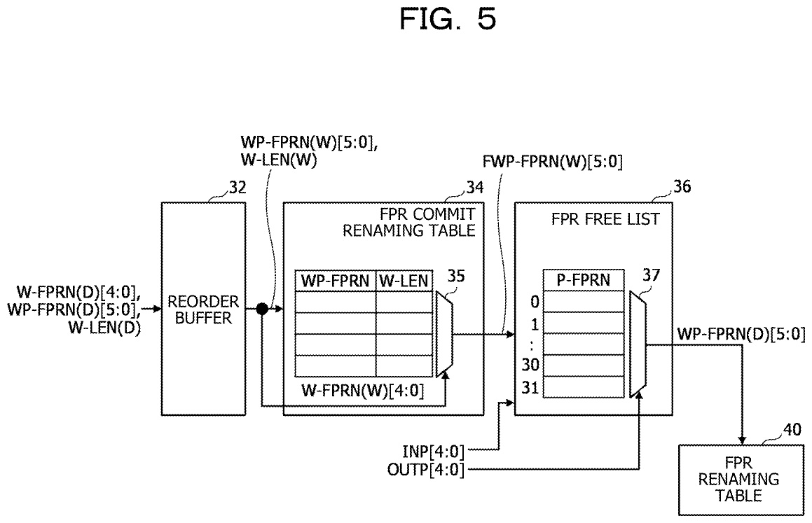

The decoding unit 30 obtains the physical register number WP-FPRN and the physical register number WP-GPRN using, for example, a method called a free list method. This makes it possible to suppress simultaneous use of the physical register number WP-FPRN and the physical register number WP-GPRN in multiple instructions. The free list method will be described with reference to FIG. 5.

When the decoding unit 30 decodes the floating-point operation instruction, it outputs the logical register number R-FPRN of the source operand included in the floating-point operation instruction to the FPR renaming table 40. When the decoding unit 30 decodes the floating-point operation instruction, it outputs the logical register number W-FPRN of the destination operand included in the floating-point operation instruction to the FPR renaming table 40.

When the decoding unit 30 decodes the floating-point operation instruction, it outputs the physical register number WP-FPRN indicating the entry of the FPR 64 used by the floating-point arithmetic unit 62 to the FPR renaming table 40 and the reservation station 50. When the decoding unit 30 decodes the floating-point operation instruction, it outputs the bit length W-LEN of the floating-point operation instruction to the FPR renaming table 40 and the reservation station 50.

When the decoding unit 30 decodes the memory access instruction, it outputs the logical register number R-GPRN of the source operand included in the memory access instruction to the GPR renaming table 42. When the decoding unit 30 decodes the memory access instruction, it outputs the logical register number W-GPRN of the destination operand included in the memory access instruction to the GPR renaming table 42.

When the decoding unit 30 decodes the load instruction, it outputs the logical register number W-GPRN of the destination operand (storage destination of load data) included in the load instruction to the GPR renaming table 42. When the decoding unit 30 decodes the load instruction, it outputs the physical register number WP-GPRN indicating the entry of the GPR 68 for storing the load data to the GPR renaming table 42 and the reservation station 52. When the decoding unit 30 decodes the store instruction, it outputs the logical register number R-GPRN of the source operand (read source of store data) included in the store instruction to the GPR renaming table 42.

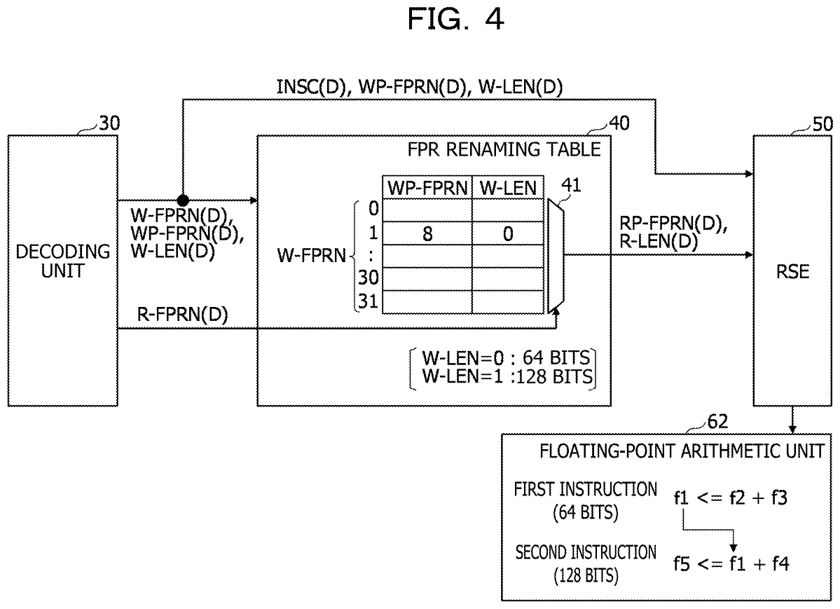

The FPR renaming table 40 has a number of entries corresponding to the number of logical registers (operands) that may be specified by the operation instruction described in a program to be executed by the arithmetic processing device 100. The FPR renaming table 40 associates the number of the logical register specified by the operation instruction with the number of the entry (physical register) of the FPR 64 used by the floating-point arithmetic unit 62. For example, the FPR renaming table 40 outputs, to the reservation station 50, the physical register number RP-FPRN and the bit length R-LEN retained in the entry indicated by the logical register number R-FPRN received from the decoding unit 30. An example of the FPR renaming table 40 will be described with reference to FIG. 4.

The GPR renaming table 42 has a number of entries corresponding to the number of logical registers (operands) that may be specified by the memory access instruction described in the program to be executed by the arithmetic processing device 100. The GPR renaming table 42 associates the number of the logical register specified by the memory access instruction with the number of the entry (physical register) of the GPR 68 used by the address generation arithmetic unit 67. The GPR renaming table 42 outputs, to the reservation station 52, the physical register number RP-GPRN and the bit length R-LEN retained in the entry indicated by the logical register number R-GPRN received from the decoding unit 30.

The reservation station 50 has a queue containing multiple entries retaining the operation instructions (including the instruction code INSC, the register numbers, etc.) and the bit lengths W-LEN and R-LEN. The reservation station 50 outputs the operation instructions including the instruction code INSC and the like retained in the entries to the floating-point arithmetic unit 62 or to a fixed-point arithmetic unit (not illustrated) out of order in the order of being executable. Furthermore, the reservation station 50 outputs, to the FPR 64, the physical register numbers WP-FPRN and RP-FPRN and the bit lengths W-LEN and R-LEN, and accesses the FPR 64. Note that, although illustration is omitted, the reservation station 50 may be connected to the fixed-point arithmetic unit and the GPR 68. Hereinafter, the reservation station 50 is also referred to as an RSE 50.

The reservation station 52 has a queue containing multiple entries retaining the memory access instructions (including the instruction code INSC, the register numbers, etc.) and the bit lengths W-LEN and R-LEN. The reservation station 52 outputs the memory access instructions including the instruction code INSC and the like retained in the entries to the address generation arithmetic unit 67 out of order in the order of being executable. The memory access instruction is a store instruction or a load instruction. Furthermore, the reservation station 52 outputs, to the GPR 68, the physical register numbers WP-GPRN and RP-GPRN and the bit lengths W-LEN and R-LEN, and accesses the GPR 68. Hereinafter, the reservation station 52 is also referred to as an RSA 52. Note that the arithmetic processing device 100 may include a reservation station obtained by integrating the reservation stations 50 and 52.

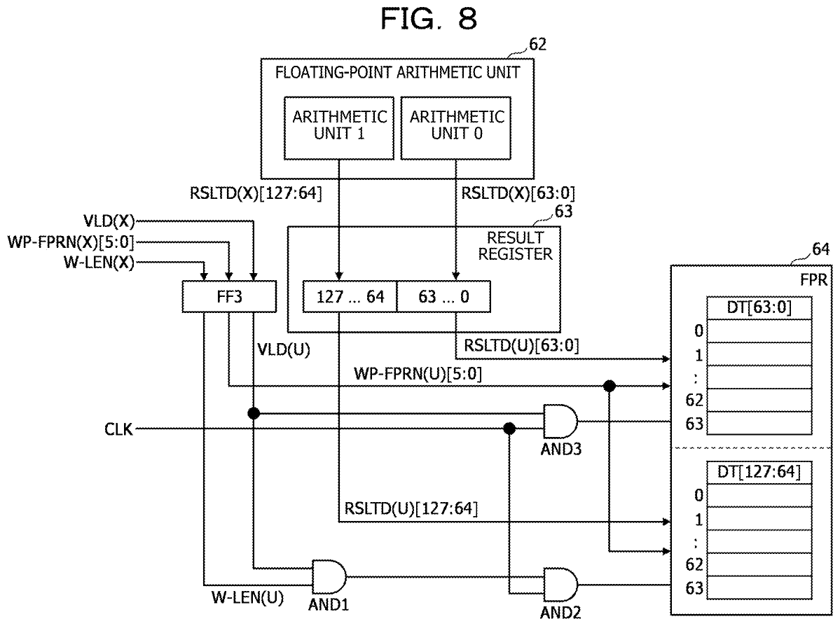

The floating-point arithmetic unit 62 reads the data to be calculated from the FPR 64 to execute the operation on the basis of the operation instruction issued from the RSE 50, and stores operation result data RSLTD in the FPR 64. The FPR 64 has multiple entries retaining the data DT. The number of entries in the FPR 64 is greater than the number of entries in the renaming table 40. The data DT retained in the FPR 64 is read from the data cache 80 on the basis of the load instruction, and is written in the data cache 80 on the basis of the store instruction. An example of the FPR 64 is illustrated in FIG. 8.

The address generation arithmetic unit 67 reads data from the GPR 68 to execute addition processing or the like on the basis of the memory access instruction issued from the RSA 52, thereby calculating a memory access address. The address generation arithmetic unit 67 outputs the memory access address obtained by the calculation to the load/store unit 70.

The load/store unit 70 has a load/store queue 72 containing multiple entries retaining the memory access instructions (memory access address and access type indicating load or store) received from the address generation arithmetic unit 67. The load/store unit 70 sequentially outputs the memory access instructions retained in the load/store queue 72 to the data cache 80, and executes data load processing or data store processing.

The data cache 80 reads the data to be accessed on the basis of the load instruction from the load/store unit 70, and transfers the read data to the FPR 64 or the GPR 68. The data cache 80 stores, in the memory area indicated by the access address, the data to be accessed transferred from the FPR 64 or the GPR 68 on the basis of the store instruction from the load/store unit 70. In a case where the data cache 80 does not retain the data to be accessed (cache miss), it reads the data from a secondary cache or a memory such as a main memory.

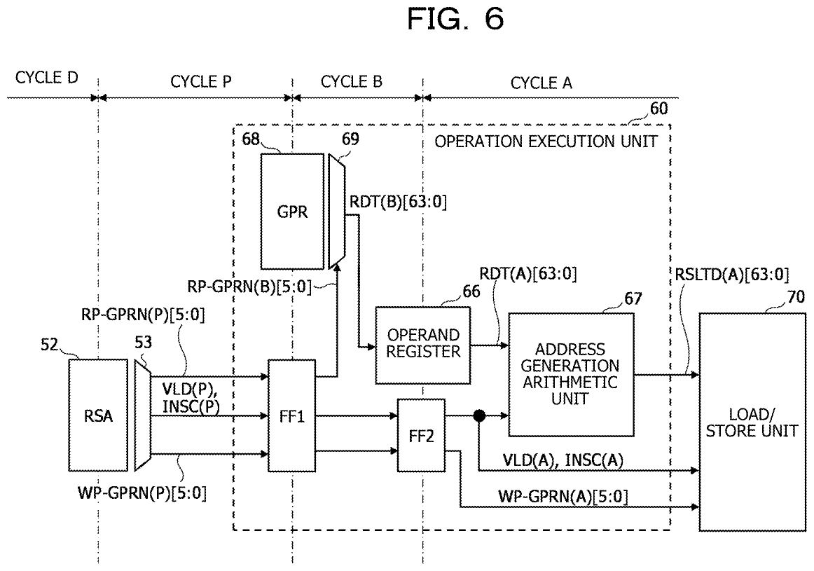

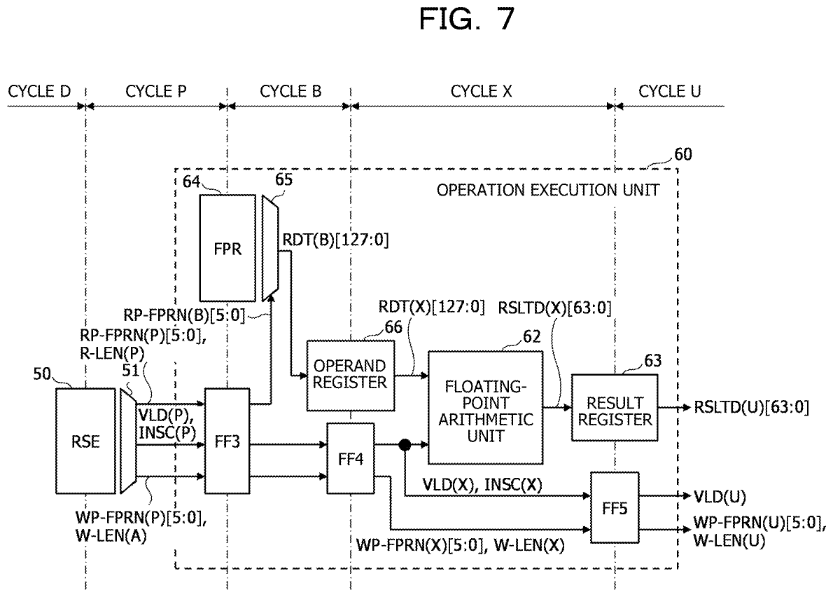

FIG. 4 illustrates an example of the FPR renaming table 40 in FIG. 3. In FIG. 4, a reference sign D indicated in parentheses at the end of a signal indicates that the signal is generated in a cycle D in FIGS. 6 and 7.

For example, the FPR renaming table 40 has 32 entries corresponding to the number of logical registers that may be specified by the operand included in the operation instruction. Each of the entries has an area for storing the physical register number WP-FPRN and the bit length W-REN.

The decoding unit 30 stores the 6-bit physical register number WP-FPRN and the bit length W-REN in the entry in the FPR renaming table 40 corresponding to the 5-bit register number W-FPRN indicating the logical register specified by the instruction. At this time, the decoding unit 30 determines the physical register number WP-FPRN using the free list method.

Furthermore, the decoding unit 30 outputs the register number R-FPRN to the selector 41 of the FPR renaming table 40. The FPR renaming table 40 reads the physical register number WP-FPRN and the bit length W-LEN from the entry indicated by the register number R-FPRN. The FPR renaming table 40 outputs, to the reservation station 50, the read physical register number WP-FPRN and the bit length W-LEN as the physical register number RP-FPRN and the bit length R-LEN.

The reservation station 50 sequentially retains the instructions (instruction code INSC, physical register numbers WP-FPRN and RP-FPRN, and bit lengths W-LEN and R-LEN) received from the decoding unit 30 and the FPR renaming table 40 in the entries. Then, the reservation station 50 outputs the instructions retained in the entries to the floating-point arithmetic unit 62 in the order of being executable.

For example, the floating-point arithmetic unit 62 sequentially executes a first instruction and a second instruction received from the reservation station 50. For example, the first instruction is a 64-bit addition instruction. The floating-point arithmetic unit 62 adds the 64-bit data retained in registers f2 and f3, and stores the 64-bit addition result in a register f1. For example, the second instruction is a 128-bit addition instruction. The floating-point arithmetic unit 62 adds the 128-bit data retained in registers f1 and f4, and stores the 128-bit addition result in a register f5.

Each of the numerical values at the end of the registers f1, f2, f3, f4, and f5 indicates a logical register number. For example, the addition result data of the first instruction is stored in the physical register (WP-FPRN=“8” in FIG. 4) corresponding to the logical register number W-FPRN. The decoding unit 30 sets the bit lengths W-LEN and R-LEN of the instruction with the bit length (bit width) of 64 bits to “0”, and the bit lengths W-LEN and R-LEN of the instruction with the bit length (bit width) of 128 bits to “1”. Note that the bit length LEN may be expanded to 2 bits or more, such as when the bit length LEN is larger than 128 bits, when the bit length is divided in units of 32 bits, or the like.

At the time of decoding the first instruction, the decoding unit 30 stores the physical register number WP-FPRN (=8) and the bit length W-LEN (=0) indicating the bit length of 64 bits in the entry in the FPR renaming table 40 corresponding to the logical register number W-FPRN (=1). At the time of decoding the second instruction, the decoding unit 30 outputs the logical register number R-FPRN (=1) to the FPR renaming table 40. The FPR renaming table 40 outputs, to the reservation station 50, the bit length R-LEN (=0) and the physical register number RP-FPRN (=8) read from the entry corresponding to the logical register number R-FPRN (=1). Then, the floating-point arithmetic unit 62 executes the second instruction.

Note that each instruction may have a plurality of source operands, such as the registers f1 and f2 in the first instruction and the registers f1 and f4 in the second instruction. Accordingly, the decoding unit 30 practically outputs, for each instruction, a plurality of the logical register numbers R-FPRN corresponding to the respective plurality of source operands. The FPR renaming table 40 outputs, to the reservation station 50, a plurality of physical register numbers RP-FPRN and the bit length R-LEN on the basis of the plurality of logical register numbers R-FPRN received in parallel. Note that the configuration and the function of the GPR renaming table 42 are similar to the configuration and the function of the FPR renaming table 40 except that the register number corresponds to the GPR 68.

FIG. 5 illustrates an exemplary method of setting the physical register number WP-FPRN to be stored in the FPR renaming table 40 in FIG. 3. In FIG. 5, reference signs D and W indicated in parentheses at the end of signals indicate that the signals are generated in the cycle D and the cycle W in FIG. 7, respectively.

The arithmetic processing device 100 includes, in addition to the configuration illustrated in FIG. 3, a reorder buffer 32, an FPR commit renaming table 34 corresponding to the FPR renaming table 40, and an FPR free list 36. Note that, although the arithmetic processing device 100 includes a GPR commit renaming table corresponding to the GPR renaming table 42 and a GPR free list, illustration thereof is omitted. A method of setting the physical register number WP-GPRN to be stored in the GPR renaming table 42 is similar to the method of setting the physical register number WP-FPRN to be stored in the FPR renaming table 40.

The reorder buffer 32 has a queue for retaining the instructions issued from the reservation station 50 out of order to complete them in the order of being written in the program. The decoding unit 30 also stores, in the reorder buffer 32, a logical register number W-FPRN1, the physical register number WP-FPRN, and the bit length W-LEN to be output to the FPR renaming table 40.

The reorder buffer 32 monitors whether the instruction registered in the queue has been executed. In a case where the instruction whose execution has been confirmed is at the head of the queue (i.e., in a case where all the preceding instructions have been complete), the reorder buffer 32 commits (completes) the instruction. The committed instruction is deleted from the reorder buffer 32, and the logical register number W-FPRN1, the physical register number WP-FPRN, and the bit length W-LEN registered in the reorder buffer 32 are transferred to the FPR commit renaming table 34.

The FPR commit renaming table 34 has multiple entries in a similar manner to the FPR renaming table 40 in FIG. 4. The correspondence between the logical register number W-FPRN and the physical register number WP-FPRN of the committed instruction is recorded in the FPR commit renaming table 34. For example, when a branch prediction fails, an uncommitted instruction is an instruction in a wrong branch direction, and thus the pipeline is cleared and abandoned.

At this time, the state of the FPR renaming table 40 is also returned to the state of the branch instruction in which the prediction has been erroneous. At that time, it is possible to restore the instruction execution state by copying the contents of the FPR commit renaming table 34 to the FPR renaming table 40. The FPR commit renaming table 34 stores the physical register number WP-FPRN and the bit length W-LEN with the logical register number W-FPRN as an index.

At this time, the physical register number WP-FPRN retained in the FPR commit renaming table 34 is no longer needed, and thus it is read using the logical register number W-FPRN and transferred to the FPR free list 36 as a free physical register number FWP-FPRN. For example, the FPR free list 36 has 32 entries.

Since the FPR 64 has 64 entries in a queue structure as illustrated in FIG. 8, there are 64 physical register numbers WP-FPRN. Of the physical register numbers WP-FPRN, 32, which is equal to the number of logical registers, are registered in the FPR renaming table 40, and thus the remaining 32 physical register numbers WP-FPRN are retained in the FPR free list 36.

The free physical register number FWP-FPRN output from the FPR commit renaming table 34 is stored in the entry in the FPR free list 36 indicated by an in-pointer INP. The in-pointer INP is incremented, for example, when the free physical register number FWP-FPRN is registered in the FPR free list 36.

Meanwhile, the physical register number WP-FPRN retained in the FPR free list 36 is read from the entry indicated by an out-pointer OUTP, and is output from the decoding unit 30 to the FPR renaming table 40 in FIG. 4. The out-pointer OUTP is incremented, for example, when the physical register number WP-FPRN is read from the FPR free list 36.

Note that the number of the physical register numbers WP-FPRN registered in the FPR free list 36 may be determined by the difference between the in-pointer INP and the out-pointer OUTP, or may be determined by a count value by a separately provided counter. In a case where there is no space in the FPR free list 36, the decoding unit 30 suppresses the instruction decoding. This makes it possible to manage the 64 unique physical register numbers WP-FPRN without excess or deficiency.

FIG. 6 illustrates an exemplary circuit for executing a load instruction or a store instruction in the operation execution unit 60 in FIG. 3. In FIG. 6, a cycle D, a cycle P, a cycle B, and a cycle A and “P”, “B”, and “A” indicated in parentheses at the end of register numbers and the like indicate cycles of an instruction pipeline. Flip-flops FF1 and FF2 are provided to tick a cycle.

The RSA 52 selects one of the accumulated load instructions and store instructions in the cycle P. The RSA 52 transfers, to the flip-flop FF1 of the operation execution unit 60, a physical register number RP-GPRN(P), a valid signal VLD(P), an instruction code INSC(P), and a physical register number WP-GPRN(P) of the selected instruction.

The valid signal VLD indicates that the instruction code INSC and the physical register numbers RP-GPRN and WP-GPRN in the same cycle are valid. Furthermore, the valid signal VLD is also used to activate the address generation arithmetic unit 67 in the cycle A, and to trigger a memory access request to the load/store unit 70.

The physical register number RP-GPRN is used to read 64-bit data RDT(B) from the GPR 68 in the cycle B. The data RDT(B) read from the GPR 68 is output to an operand register 66. Note that, although illustration is omitted, there are two physical register numbers RP-GPRN and two pieces of data ROT when there are two source operands of the operation instruction, for example.

The address generation arithmetic unit 67 executes the operation of generating a memory access address in the cycle A using data RDT(A) output from the operand register 66. The generated memory access address is output to the load/store unit 70 as 64-bit operation result data RSLTD(A).

The instruction code INSC is used to instruct address calculation and to instruct the load/store unit 70. While the instruction to the load/store unit 70 is, for example, a load or store instruction, it may include a more complex multi-bit instruction. The load/store unit 70 executes memory access using the operation result data RSLTD(A) and the instruction code INSC with the valid signal VLD(A) as a trigger. For example, in the case of the load instruction, the data loaded from the memory is stored in any of the 64 entries in the GPR 68 or in the 64 entries in the FPR 64 using the 6-bit physical register number WP-GPRN.

FIG. 7 illustrates an exemplary circuit for executing the operation instruction in the operation execution unit 60 in FIG. 3. Detailed descriptions of elements similar to those in FIG. 6 will be omitted. In FIG. 7, a cycle D, a cycle P, a cycle B, a cycle X, and a cycle U and “P”, “B”, “X”, and “U” indicated in parentheses at the end of register numbers and the like indicate cycles of the instruction pipeline. Flip-flops FF3, FF4, and FF5 are provided to tick a cycle.

The RSE 50 selects one of the accumulated floating-point operation instructions in the cycle P. The RSE 50 transfers, to the flip-flop FF3 of the operation execution unit 60, physical register numbers RP-FPRN(P) and WP-FPRN(P), a valid signal VLD(P), an instruction code INSC(P), and bit lengths R-LEN(P) and W-LEN(A) of the selected floating-point operation instruction.

The valid signal VLD indicates that the instruction code INSC and the physical register numbers RP-FPRN and WP-FPRN in the same cycle are valid. Furthermore, the valid signal VLD is also used to activate the floating-point arithmetic unit 62 in the cycle X.

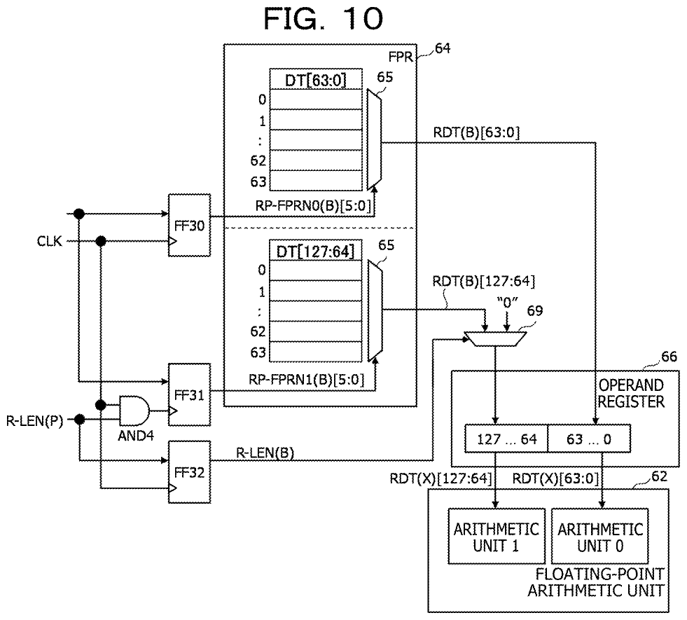

The physical register number RP-FPRN and the bit length R-LEN are used to read the 128-bit data RDT(B) from the FPR in the cycle B, which will also be explained with reference to FIG. 10 to be described later. The data RDT(B) read from the FPR 64 is output to the operand register 66. Note that, although illustration is omitted, there are three physical register numbers RP-GPRN and three pieces of data RDT when there are three source operands of the operation instruction, for example.

The floating-point arithmetic unit 62 executes a floating-point operation in the cycle X using data RDT(X) output from the operand register 66. The operation result generated by the floating-point arithmetic unit 62 is transferred to a result register 63 as operation result data RSLTD(X).

The instruction code INSC is used to instruct the floating-point operation. Although illustration is omitted, the instruction code INSC may include multiple bits depending on the number of types of the corresponding operation. As will be described with reference to FIG. 8, in the cycle U, operation result data RSLTD(U) is stored in the entry in the FPR 64 indicated by a physical register number WP-FPRN(U) and a bit length W-LEN(U) with a valid signal VLD(U) serving as a write enable signal. The reading of the data RDT(B) from the FPR 64 in the cycle B will be described with reference to FIG. 10. Note that the RSE 50 is capable of selecting a fixed-point operation instruction and executing a fixed-point operation using the data RDT(B) from the GPR 68.

FIG. 8 illustrates an exemplary circuit for writing data to the FPR 64 in FIG. 3. In FIG. 8, reference signs X and U indicated in parentheses at the end of signals indicate that the signals are generated in the cycle X and the cycle U in FIG. 7, respectively. The FPR 64 has 64 entries retaining the 128-bit data DT. Accordingly, the physical register number WP-FPRN for identifying the entry in the FPR 64 is represented by 6 bits [5:0]. Note that, although illustration is omitted, the GPR 64 has 64 entries retaining the 128-bit data DT in a similar manner to the FPR 64.

While the FPR 64 is divided into low-order bits [63:0] and high-order bits [127:64] in FIG. 8 for the sake of clarity, the entries with the same physical register number WP-FPRN are accessed simultaneously. Hereinafter, the entry corresponding to the physical register number WP-FPRN=“1” will also be referred as an entry FPR1, for example.

FIG. 8 illustrates an example in which the operation result data RSLTD is written from the floating-point arithmetic unit 62 to the FPR 64. For example, the floating-point arithmetic unit 62 is capable of executing two 64-bit operations simultaneously (2SIMD operations). In the case of executing the SIMD operation using the FPR 64 with the data width of 128 bits, for example, the floating-point arithmetic unit 62 operates as two 64-bit arithmetic units 0 and 1. The arithmetic unit 0 and the arithmetic unit 1 are exemplary sub arithmetic units.

The arithmetic unit 0 calculates the low-order bit side of the data, and the arithmetic unit 1 calculates the high-order bit side of the data. Note that, in a case where the floating-point arithmetic unit 62 executes the 128-bit operation instruction, for example, a carry from the arithmetic unit 0 is transmitted to the arithmetic unit 1, and the arithmetic unit 0 and the arithmetic unit 1 operate in cooperation with each other.

When the valid signal VLD is valid, the operation result data RSLTD [63:0] by the arithmetic unit 0 is stored in the low-order bit side of the entry in the FPR 64 indicated by the physical register number WP-FPRN [5:0] in synchronization with a clock CLK. For example, the valid level of the valid signal VLD is a logical value 1.

In a case where the valid signal VLD is valid and the bit length W-LEN is “1”, the operation result data RSLTD [127:64] by the arithmetic unit 1 is stored in the high-order bit side of the entry in the FPR 64 indicated by the physical register number WP-FPRN [5:0] in synchronization with the clock CLK.

The entry in the FPR 64 is an exemplary register, and the low-order bit side and the high-order bit side of the entry are exemplary subregions.

When the bit length W-LEN is “0”, the storage of the operation result data RSLTD [127:64] in the FPR 64 is masked by AND circuits AND1 and AND2. The AND circuits AND1 and AND2 are exemplary mask circuits for determining whether or not to mask the storage of the operation result data RSLTD [127:64] in the FPR 64.

As described above, the bit length W-LEN of “0” indicates a 64-bit operation, and the bit length W-LEN of “1” indicates a 128-bit operation. Accordingly, when the bit length W-LEN is “0”, the operation result data RSLTD [127:64] output from the arithmetic unit 1 is an invalid value. In this case, according to the instruction set architecture specification, for example, the value of the FPR 64 to be updated is expected to be a zero value.

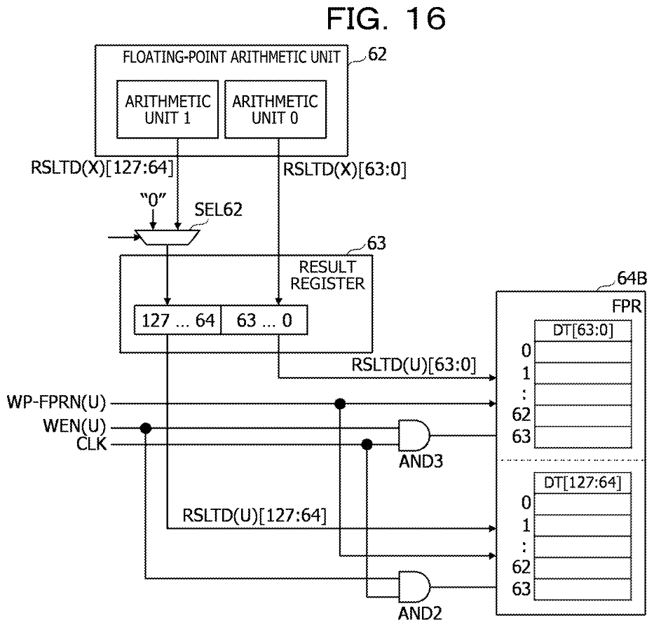

In the present embodiment, the guarantee of the zero value of the upper 64 bits at the time of the 64-bit operation is implemented when source operand data is read from the FPR, as will be described with reference to FIG. 10. Accordingly, when the data RSLTD is stored in the FPR 64 as illustrated in FIG. 8, writing of the zero value to the FPR 64 is not executed. The signal line of the operation result data RSLTD output from the arithmetic unit 1 is directly connected to the FPR 64 via the result register 63, unlike the case of FIG. 16 to be described later.

When the bit length W-LEN is “0”, the operation result data RSLTD [127:64] from the arithmetic unit 1 is an invalid value, and does not affect the operation of the subsequent instruction regardless of whether or not the FPR 64 [127:64] is updated. However, when the bit length W-LEN is “0”, the power consumption of the FPR 64 may be reduced by stopping the supply of the clock CLK to the FPR 64 [127:64] with the AND circuits AND1 and AND2. On the other hand, when the bit length W-LEN is “1”, the valid operation result data RSLTD [127:64] output from the arithmetic unit 1 is stored in the FPR 64 [127:64] in synchronization with the clock CLK.

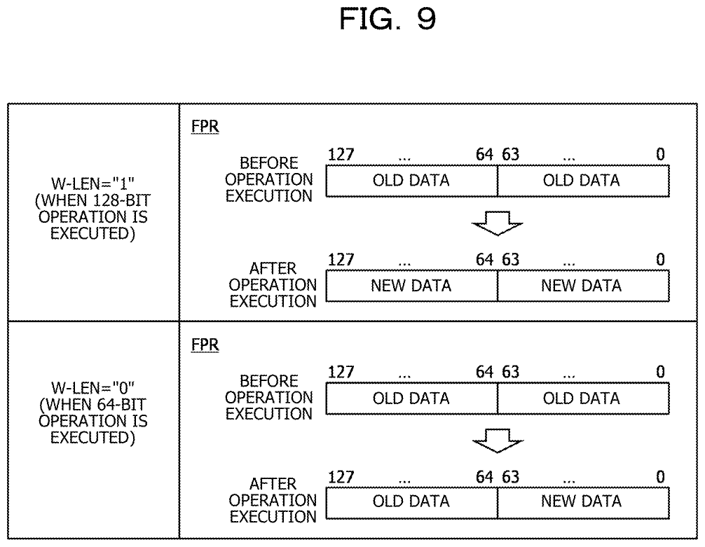

FIG. 9 illustrates an outline of the data writing to the FPR 64 in FIG. 3. When the bit length W-LEN is “1” (at the time of executing the 128-bit operation), all bits [127:0] of the entries to be calculated in the FPR 64 are updated from old data OLD to new data NEW by the execution of the floating-point operation instruction.

On the other hand, when the bit length W-LEN is “0” (at the time of executing the 64-bit operation), low-order 64 bits [63:0] of the entries to be calculated in the FPR 64 are updated from the old data OLD to the new data NEW by the execution of the floating-point operation instruction. The high-order 64 bits [127:64] of the entries to be calculated in the FPR 64 are not updated (with no zero-value writing), and are maintained in the old data OLD.

FIG. 10 illustrates an exemplary circuit for reading data from the FPR 64 in FIG. 3. In FIG. 10, reference signs P, B, and X indicated in parentheses at the end of signals indicate that the signals are generated in the cycle P, the cycle B, and the cycle W in FIG. 7, respectively. Flip-flops FF30, FF31, and FF32 correspond to the flip-flop FF3 in FIG. 7.

The flip-flop FF30 inputs the physical register number RP-FPRN to the selector 65 on the low-order bit [63:0] side of the FPR 64 in synchronization with the clock CLK. Then, the data RDT [63:0] is output from the entry in the FPR 64 indicated by the physical register number RP-FPRN, and is stored in the low-order bit [63:0] side of the operand register 66.

The flip-flop FF31 receives the clock CLK via an AND circuit AND4 that receives the bit length R-LEN. The AND circuit AND4 outputs the clock CLK to the flip-flop FF31 when the bit length R-LEN is “1”, and stops the output of the clock CLK to the flip-flop FF31 when the bit length R-LEN is “0”. The AND circuit AND4 is an exemplary clock stop circuit.

When the bit length R-LEN is “1” indicating 128-bit data, the flip-flop FF31 inputs the physical register number RP-FPRN to the selector 65 on the high-order bit [127:64] side of the FPR 64 in synchronization with the clock CLK. Then, the data RDT [127:64] is output from the entry in the FPR 64 indicated by the physical register number RP-FPRN. A selector 69 selects the data RDT [127:64] when the bit length R-LEN output from the flip-flop FF32 is “1”. Then, the data RDT [127:64] is stored in the high-order bit [127:64] side of the operand register 66 via the selector 69. Therefore, when the bit length R-LEN is “1”, the 128-bit data RDT [127:0] output from the FPR 64 is stored in the operand register 66.

On the other hand, when the bit length R-LEN is “0” indicating 64-bit data, the flip-flop FF31 does not receive clock CLK, and does not output the physical register number RP-FPRN to the FPR accordingly. When the bit length R-LEN is “0”, the high order [127:64] side of the FPR 64 retains invalid data. It becomes possible to reduce the power consumption by suppressing the reading of the invalid data.

As described above, after executing the 64-bit operation, the high-order bit [127:64] side of the operation result data RSLTD is expected to be updated to the zero value according to the instruction set architecture specification. For example, it is expected that the zero value is written to the high-order bit [127:64] side of the operand register 66. When the bit length R-LEN output from the flip-flop FF32 is “0”, the selector 69 selects a zero value, and stores the selected zero value in the high-order bit [127:64] side of the operand register 66. The selector 69 is an exemplary data replacement circuit that replaces the data output from the high-order bit [127:64] of the FPR 64 with a zero value.

Therefore, when the bit length R-LEN is “0”, the 64-bit data RDT [63:0] output from the FPR 64 is written to the low-order bit [63:0] of the operand register 66. Furthermore, a zero value is written to the high-order bit [127:64] of the operand register 66. For example, it is possible to implement the setting of data not used for the operation defined by the instruction set architecture to the zero value at the time of storing the data RDT [127:0] in the operand register 66. Note that, in a case where the increase in power consumption at the time of the reading operation of the data RDT [127:64] from the FPR 64 is allowed when the bit length R-LEN is “0”, the AND circuit AND may not be arranged and the clock CLK may be directly supplied to the flip-flop FF31. In this case as well, according to the operation of the selector 69, a zero value is written to the high-order bit [127:64] of the operand register 66.

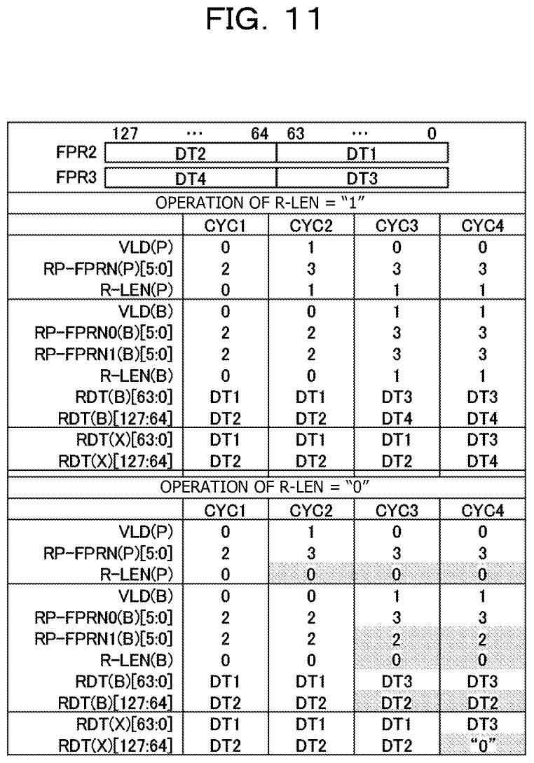

FIG. 11 illustrates exemplary operation of reading data from the FPR 64 with the circuit illustrated in FIG. 10. In the operation illustrated in FIG. 11, it is assumed that data DT1 is retained in the low-order bit [63:0] of an entry FPR2 of the FPR 64, and data DT2 is retained in the high-order bit [127:64] of the entry FPR2. It is assumed that data DT3 is retained in the low-order bit [63:0] of an entry FPR3 of the FPR 64, and data DT4 is retained in the high-order bit [127:64] of the entry FPR3.

First, an operation when the bit length R-LEN is “1” will be described. In a cycle CYC1, since the valid signals VLD(P) and VLD(B) are “0”, old values remain in physical register numbers RP-FPRN(P), RP-FPRNO(B), and RP-FPRN1(B) and bit lengths R-LEN(P) and R-LEN(B).

In a cycle CYC2, the valid signal VLD(P) becomes “1”, the physical register number RP-FPRN(P) is updated to “3”, and the bit length R-LEN(P) is updated to “1”. Since a cycle P signal becomes the cycle B in a cycle CYC3, the valid signal VLD(B) becomes “1” in the cycle CYC3.

In the cycle CYC3, the physical register numbers RP-FPRN0(B) and RP-FPRN1(B) are set to “3” by the physical register number RP-FPRN(P) in the cycle CYC2. The value of the physical register number RP-FPRN1(B) depends on the value of the bit length R-LEN(P). Since the AND circuit AND4 in FIG. 10 receives the bit length R-LEN(P)=“1” and outputs the clock CLK, the physical register number RP-FPRN1(B) is set to “3”, which is the same as RP-FPRN(P) in the cycle CYC2. The physical register number RP-FPRN0(B) does not depend on the value of the bit length R-LEN(P), and is set to “3”, which is the same as RP-FPRN(P) in the cycle CYC2.

Since the physical register numbers RP-FPRN0(B) and RP-FPRN1(B) are both “3”, the data RDT(B) [63:0] (=“DT3”) and RDT(B) [127:64] (=“DT4”) are read from the entry FPR3 of the FPR 64. Since R-LEN(B) is “1”, the selector 65 in FIG. 10 selects the data RDT(B) [127:64] from the FPR. Accordingly, the operand register 66 in FIG. 10 outputs the data RDT(X) [127:64]=“DT4” in a cycle CYC4.

Next, an operation when the bit length R-LEN is “0” will be described. Detailed descriptions of operations similar to those in the case where the bit length R-LEN is “1” will be omitted. Operations different from those in the case where the bit length R-LEN is “1” are indicated by being shaded. The bit lengths R-LEN(P) and R-LEN(B) are set to “0” regardless of the cycle.

The operation in the cycle CYC1 is similar to the operation when the bit length R-LEN is “1”. The operation in the cycle CYC2 is similar to the operation when the bit length R-LEN is “1” except that the bit length R-LEN(P) is set to “0”.

Since the bit length R-LEN(P) is “0” in the cycle CYC3, the AND circuit AND4 in FIG. 10 does not output the clock CLK. Accordingly, the physical register number RP-FPRN1(B) is maintained at “2”, which is the same as RP-FPRN1(B) in the cycle CYC2. The data RDT(B) [127:64] output from the FPR 64 is maintained at “DT2” output from the entry FPR2 of the FPR. Since the R-LEN(B) is “0”, the selector 65 selects “0”. Meanwhile, the physical register number RP-FPRNO(B) is updated to “3” regardless of the bit length R-LEN(P), the data RDT(B) [63:0] (=“DT3”) is read from the entry FPR3 of the FPR 64.

In the cycle CYC4, the operand register 66 outputs “0” selected by the selector 69 as data RDT(X) [127:64] instead of “DT2” retained in the entry FPR2 of the FPR 64.

As described above, in the present embodiment as well, it is possible to obtain effects similar to those of the above-described embodiment. For example, it becomes possible to reduce the power consumption at the time of zero value writing to the FPR 64, and to reduce the power consumption of the arithmetic processing device 100 by suppressing the zero-value writing to the high-order bit side of the FPR 64 not used for the operation instruction.

Furthermore, it becomes possible to correctly execute the operation by replacing, with a zero value, the high-order bit side of the data read for the 128-bit operation instruction from the entry of the FPR 64 in which the 64-bit operation result data RSLTD is stored. As a result, even in a case of suppressing partial data writing to the FPR 64 to reduce the power consumption, the arithmetic processing device 100 is enabled to execute the operation correctly.

Moreover, according to the present embodiment, it becomes possible to suppress the zero-value writing to the FPR 64 by stopping the supply of the clock CLK to the high-order bit side of the FPR 64 using simple circuits such as the AND circuits AND1 and AND2, and the like. As a result, it becomes possible to suppress the zero-value writing to the FPR 64, and to reduce the power consumption of the arithmetic processing device 100 while suppressing an increase in the circuit scale of the arithmetic processing device 100.

It becomes possible to suppress the invalid data reading, and to reduce the power consumption of the arithmetic processing device 100 by suppressing the supply of the clock CLK to the read circuit on the high-order bit side of the FPR 64 retaining the data to be replaced with the zero value.

The decoding unit 30 outputs, to the renaming table 40, the bit length W-LEN together with the physical register number WP-FPRN for each instruction. As a result, it becomes possible to transfer the bit lengths W-LEN and R-LEN to the operation target circuit together with instruction information such as a register number and the like in each cycle of the pipeline, and to correctly execute the suppression of the zero-value writing and the data replacement with the zero value for each instruction.

Furthermore, the reservation station 50 receives the instruction code INSC, the physical register number WP-FPRN, and the bit length W-LEN from the decoding unit 30, and receives the physical register number RP-FPRN and the bit length R-LEN from the renaming table 40. As a result, in the arithmetic processing device 100 that executes instructions out of order in the order of being executable, it becomes possible to correctly execute the suppression of the zero-value writing and the data replacement with the zero value for each instruction.

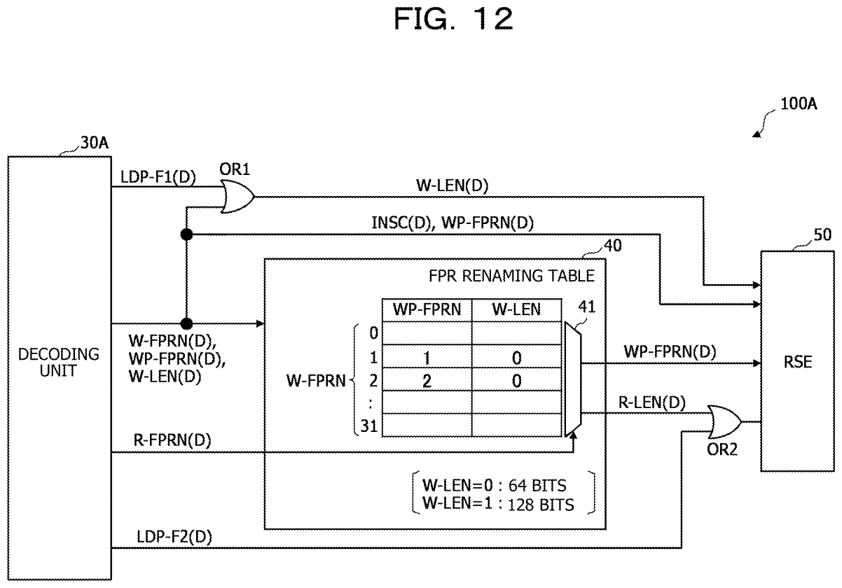

FIG. 12 illustrates an exemplary arithmetic processing device according to another embodiment. Elements similar to those in FIGS. 3 to 10 are denoted by the same reference signs, and detailed descriptions thereof will be omitted. An arithmetic processing device 100A illustrated in FIG. 12 includes a decoding unit 30A instead of the decoding unit 30 in FIG. 3, and newly includes OR circuits OR1 and OR2. Other components of the arithmetic processing device 100A are similar to the components of the arithmetic processing device 100 of FIG. 3.

The arithmetic processing device 100A has a function of updating multiple entries of the FPR 64 or the GPR 68 in FIG. 3 by one instruction, for example, in a similar manner to an ldp instruction of ARM (registered trademark). For example, the arithmetic processing device 100A is capable of executing the ldp instruction that divides data loaded from one address in a memory area into two and stores them in any two entries of the FPR 64 or the GPR 68, respectively. The ldp instruction is an exemplary division load instruction.

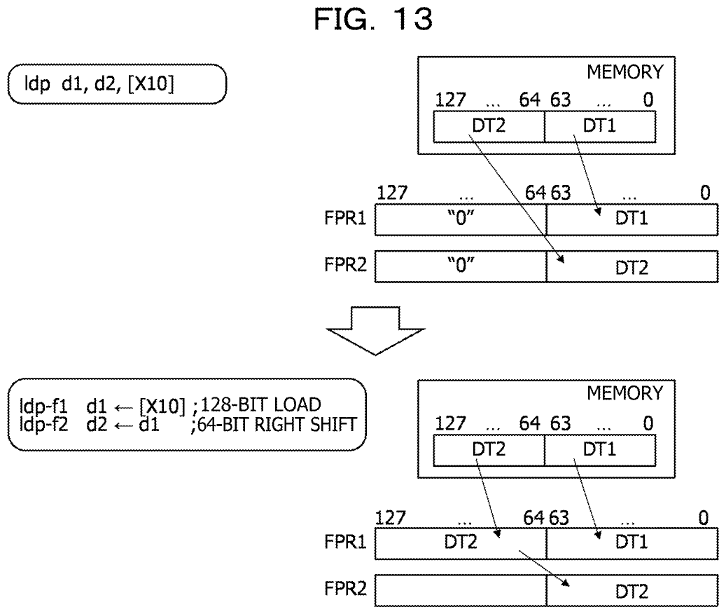

The decoding unit 30A decodes the ldp instruction as a 64-bit instruction. Accordingly, when the decoding unit 30A has decoded the ldp instruction, it outputs a bit length W-LEN of “0” together with a physical register number RP-FPRN and the like in a cycle D. Furthermore, the decoding unit 30A sets control signals LDP-F1(D) and LDP-F2(D) to “1” in the cycle D to sequentially execute two flows ldp-f1 and ldp-f2 to be described with reference to FIG. 13. The flow ldp-f1 is an exemplary first instruction, and the flow ldp-f2 is an exemplary second instruction.

When the OR circuit ORI receives the control signal LDP-FI(D) of “1”, it outputs a bit length W-LEN(D) of “1” to an RSE 50 regardless of the bit length W-LEN(D) output by the decoding unit 30A. As a result, in the flow ldp-f1 illustrated in FIG. 13, masking of storage of a high-order bit [127:64] data to an entry FPR1 is released at the time of loading data from a memory to the entry FPR1 of the FPR 64 as a 64-bit instruction.

When the OR circuit OR2 receives the control signal LDP-F2(D) of “1”, it outputs a bit length R-LEN(D) of “1” to the RSE 50 regardless of the bit length R-LEN(D) output from an FPR renaming table 40. As a result, in the flow ldp-f2 illustrated in FIG. 13, replacement of the high-order bit [127:64] of the entry FPR1 with a zero value is suppressed at the time of transferring 64-bit data from the FPR 64 to an entry FPR2 as a 64-bit instruction.

FIG. 13 illustrates an exemplary load instruction to be executed by the arithmetic processing device 100A of FIG. 12. The ldp instruction illustrated on the upper part of FIG. 13 is described by “ldp d1, d2, [x10]”. In this description, first, 128-bit data in the memory area indicated by the data (address) retained in the entry in the GPR 68 specified by a logical register number=“10” is read from the memory (or a data cache 80). Then, the read data is stored in, for example, the two entries FPR1 and FPR2 of the FPR 64 specified by logical register numbers “d1” and “d2”, respectively, for each 64-bit data DT1 and DT2. In order to implement this operation, the arithmetic processing device 100A divides the ldp instruction into the two flows ldp-f1 and ldp-f2 and executes them as illustrated in the lower part of FIG. 13.

Note that the high-order bits [127:64] of the entries FPR1 and FPR2 are set to “0” in the upper part of FIG. 13. However, as described with reference to FIG. 10, the high-order bit [127:64] is set to “0” at the time of reading when the bit length R-LEN is “0” in the present embodiment. Accordingly, the high-order bits [127:64] of the entries FPR1 and FPR2 may retain old data in a similar manner to FIG. 9. The entry FPR1 is an exemplary first register, and the entry FPR2 is an exemplary second register.

At the lower part of FIG. 13, the flow ldp-f1 loads the 128-bit data DT1 and DT2 from the memory, and stores the loaded data DT1 and DT2 in the entry FPR1 of the FPR 64 specified by the register d1. While it is sufficient if only the low-order bit [63:0] is stored in the register d1, the high-order bit [127:64] may be used as data to be stored in the register d2 in the flow ldp-f2 by storing 128 bits. Furthermore, since the high-order bit [127:64] is read as a zero value at the time of reading, even when invalid data is stored, the subsequent operation may be correctly executed.

As described with reference to FIG. 12, the decoding unit 30A decodes the ldp instruction as a 64-bit operation, and sets the individual bit lengths W-LEN and R-LEN to “0”. However, in the flow ldp-f1, the bit length W-LEN of “0” output from the decoding unit 30A is converted to “1” by the OR circuit OR1 that receives the control signal LDP-FI(D) of “1”, and is output to the RSE 50. Accordingly, even in a case where the decoding unit 30A outputs the bit length W-LEN of “0”, it is possible to store 128-bit data read from the memory by a load/store unit 70 in the FPR 64 (FIG. 8) without masking.

Note that, since the ldp instruction is a 64-bit instruction, the bit length W-LEN of “0” is stored in the renaming table 40. Accordingly, even in a case where the 128-bit data is stored in the entry FPR1 of the FPR 64, it is possible to supply it to an arithmetic unit 1 via an operand register 66 with the high-order bit [127:64] set to “0” by the selector 65 in FIG. 10 in the subsequent instruction.

The flow ldp-f2 reads to the data stored in the register dl in the flow ldp-f1, and shifts the high-order bit [127:64] (=DT2) to the right by 64 bits using a floating-point arithmetic unit 62. Then, the 64-bit data DT2 shifted to the right is stored in the low-order bit [63:0] of the register d2. For example, the register d2 corresponds to the entry FPR2 of the FPR 64.

In the flow ldp-f2, the bit length R-LEN of “0” output from the renaming table 40 is converted to “1” by the OR circuit 0R2 that receives the control signal LDP-F2(D) of “1”, and is output to the RSE 50. Accordingly, even in a case where the decoding unit 30A decodes the ldp instruction as a 64-bit instruction, it is possible to read 128-bit data from the entry FPR1 of the FPR 64.

For example, in a case where an increase in circuit area is allowed, it becomes possible to update the two entries FPR with one load instruction by increasing a write port of the FPR 64. Meanwhile, according to the present embodiment, the OR circuits OR1 and OR2 are added so that one load instruction is divided into two instruction processing flows and one load instruction updates the two entries FPR, whereby the increase in circuit area may be suppressed.

According to the circuit configuration illustrated in FIG. 12, the arithmetic processing device 100A is enabled to execute instruction processing every cycle by including, for example, one pipeline for load instructions and one floating-point arithmetic unit 62. As a result, it becomes possible to efficiently execute the instruction processing, and to achieve high throughput.

On the other hand, in an arithmetic processing device to which the present embodiment is not applied, for example, a flow ldp-f3 for embedding “0” in the register d1 is added in addition to the flows ldp-f1 and ldp-f2. In this case, the operation time of the floating-point arithmetic unit 62 produces a bottleneck so that the instruction may be processed only once every two cycles, whereby the instruction processing throughput may be halved.

The problem of the decreased instruction processing throughput is cleared by increasing the number of floating-point arithmetic units 62 and instruction pipelines. However, the number of readings and the number of writings of the FPR 64 by the floating-point arithmetic unit 62 increase, and the circuit area also increases.

Furthermore, it is also conceivable to divide the ldp instruction into two loads as another control. However, when there is one load pipeline, the instruction is processed once every two cycles, and the instruction processing throughput is halved. Although the problem may be cleared by increasing the number of load pipelines in this case as well, for example, the number of readings of the data cache 80 increases, and the circuit area also increases.

As described above, in the present embodiment as well, it is possible to obtain effects similar to those of the above-described embodiment. Moreover, in the present embodiment, the decoding unit 30A treats the ldp instruction, which is a combination of multiple 64-bit load instructions, as a 64-bit operation instruction, and outputs the bit lengths W-LEN and R-LEN of “0”. Corresponding to the flow ldp-f1, the OR circuit OR1 converts “0” of the bit length W-LEN output from the decoding unit 30A to “1”, and outputs it to the reservation station 50. Corresponding to the flow ldp-f2, the OR circuit 0R2 converts “0” of the bit length R-LEN output from the FPR renaming table 40 to “1”, and outputs it to the reservation station 50.

As a result, the arithmetic processing device 100A is enabled to store the 128-bit data from the memory in the entry of the FPR 64 at the time of executing the flow ldp-f1. Then, at the time of executing the flow ldp-f2, the arithmetic processing device 100A reads the high-order bit of the 128-bit data stored in the entry of the FPR 64 to store it in another entry of the FPR 64 as 64-bit data.

Furthermore, it is possible to minimize the increase in the circuit area and to improve the ldp instruction throughput without largely changing the structure of the arithmetic processing device 100A with respect to the arithmetic processing device 100 illustrated in FIG. 3. Furthermore, in a case where both the load pipeline and the floating-point arithmetic pipeline may be increased, it is possible to improve the instruction processing throughput according to the increased number.

Note that the embodiments described above have explained the example of being applied to the arithmetic processing devices 100 and 100A including the FPR 64 with the data bit width of 128 bits and the floating-point arithmetic unit 62 capable of executing 64-bit 2SIMD operations. However, the data bit width of the FPR 64 and the floating-point arithmetic unit 62 may be larger or smaller than 128 bits.

Furthermore, the embodiments described above may be applied to processing of smaller data width operations such as single-precision floating point operations, not limited to the SIMS operations. In that case, for example, it is possible to correspond to four-bit lengths W-LEN and R-LEN by increasing the number of bits of the bit lengths W-LEN and R-LEN to 2 or more. Moreover, while the embodiments described above have been described using the FPR 64 as an example, they may be applied to another operation register such as the GPR 68 and the like. Furthermore, the embodiments described above may be applied not only to the case of focusing on the operation result writing but also to the case of focusing on the load instruction writing.

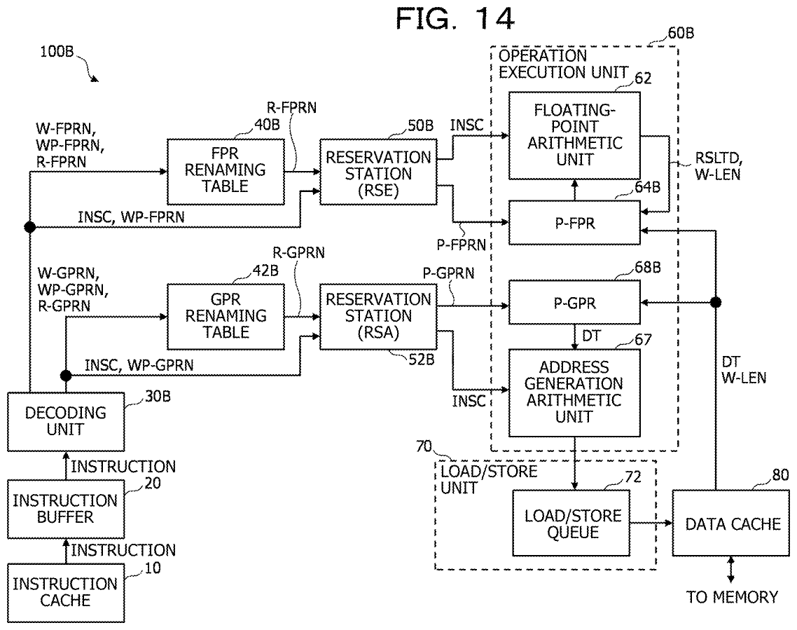

FIG. 14 is a block diagram illustrating an example of another arithmetic processing device. Elements similar to those in the embodiments described above are denoted by the same reference signs, and detailed descriptions thereof will be omitted. An arithmetic processing device 1008 illustrated in FIG. 14 includes a decoding unit 30B, an FPR renaming table 40B, and a GPR renaming table 42B instead of the decoding unit 30, the FPR renaming table 40, and the GPR renaming table 42 in FIG. 1. Furthermore, the arithmetic processing device 100E includes reservation stations 50B and 52B and an operation execution unit 60B instead of the reservation stations 50 and 52 and the operation execution unit 60 in FIG. 1. The operation execution unit 60B includes an FPR 64B and a GPR 68B instead of the FPR 64 and the GPR 68 in FIG. 3. Other components and functions of the arithmetic processing device 100B are similar to the components of the functions of the arithmetic processing device 100 of FIG. 3.

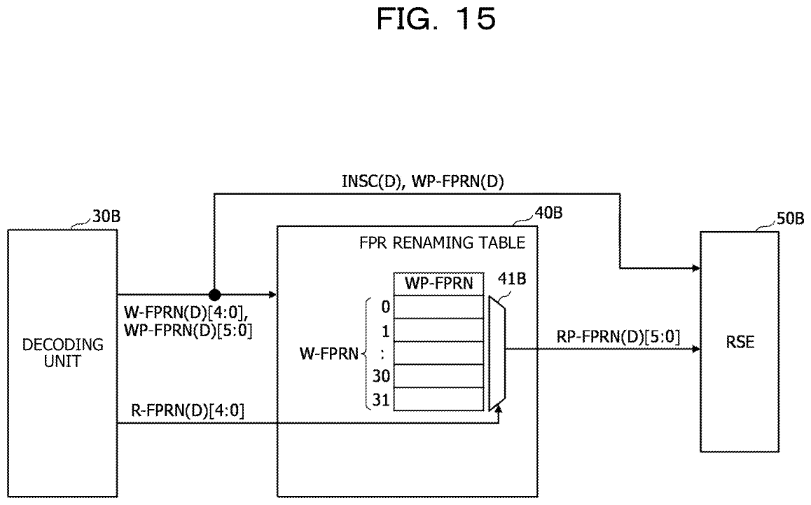

FIG. 15 is a block diagram illustrating an example of the FPR renaming table 40B in FIG. 14. The FPR renaming table 40B has configurations and functions similar to those of the FPR renaming table 40 in FIG. 4 except that it does not have an area for retaining the bit length W-LEN and does not have a function of outputting the bit length R-LEN.

The decoding unit 30B has functions similar to those of the decoding unit 30 in FIG. 3 except that it does not have a function of outputting the bit length W-LEN. The reservation station 50B has configurations and functions similar to those of the reservation station 50 in FIG. 3 except that it does not have a function of inputting/outputting the bit lengths W-LEN and R-LEN.

Although illustration is omitted, the GPR renaming table 42B has configurations and functions similar to those of the FPR renaming table 40 in FIG. 4 except that it does not have an area for retaining the bit length W-LEN and does not have a function of outputting the bit length R-LEN. Although illustration is omitted, the reservation station 52B has configurations and functions similar to those of the reservation station 52 in FIG. 3 except that it does not have a function of inputting/outputting the bit lengths W-LEN and R-LEN.

FIG. 16 illustrates an exemplary circuit for writing data to the FPR 64B in FIG. 14. The circuit for writing data to the FPR 64B is similar to the circuit for writing data to the FPR 64 in FIG. 8 except that it does not include the AND circuit AND1 in FIG. 8 and includes a selector SEL62 between the arithmetic unit 1 and the result register 63.

At the time of executing the 64-bit operation, the arithmetic processing device 100B uses the selector SEL62 to replace invalid operation result data RSLTD(X) [127:64] with a zero value and to transfer it to the result register 63. Then, the arithmetic processing device 100B stores the zero value in the high-order bit [127:64] of the target entry in the FPR 64 via the result register 63. In a case of storing the zero value in the high-order bit [127:64] of the FPR 64 each time the 64-bit operation is executed, the power consumption increases as compared with a case of masking the data storage in the high-order bit [127:64] of the FPR 64.

A circuit for controlling the FPR 64B has configurations and functions similar to those of the circuit for controlling the FPR 64 in FIG. 8 except that it does not have a function of masking the data storage in the high-order bit [127:64] according to the logical value of the bit length W-LEN. Although illustration is omitted, a circuit for controlling the GPR 68B has configurations and functions similar to those of the circuit for controlling the FPR 64 in FIG. 8 except that it does not have a function of masking the data storage in the high-order bit [127:64] according to the logical value of the bit length W-LEN. Furthermore, the circuit for controlling the GPR 64B has configurations and functions similar to those of the circuit for controlling the FPR 64 in FIG. 10 except that it does not have a function of setting the high-order bit [127:64] of the data to “0” according to the logical value of the bit length R-LEN and outputting it.

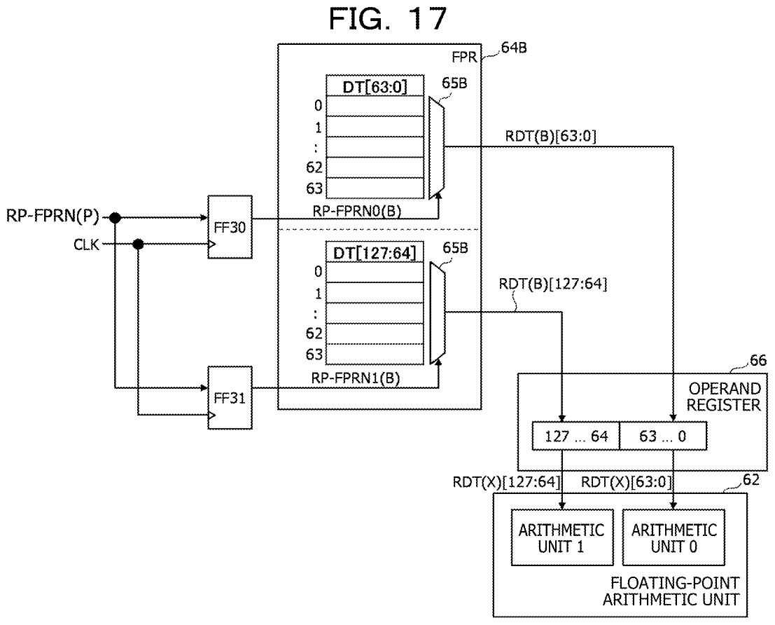

FIG. 17 illustrates an example of the circuit for reading data from the FPR 64B in FIG. 14. The circuit for reading data from the FPR 64B is similar to the circuit for reading data from the FPR 64 in FIG. 10 except that it does not include the AND circuit AND4, the flip-flop FF32, and the selector 69 in FIG. 10.

At the time of executing the 64-bit operation, the arithmetic processing device 100B reads the zero-value data RDT(B) [127:64] retained in the high-order bit [127:64] of the FPR 64B, and stores it in the operand register 66. In a case of executing the 128-bit operation using the 64-bit operation result, the zero value stored in the high-order bit [127:64] of the FPR 64B is read, whereby the floating-point arithmetic unit 62 is enabled to correctly execute the operation.

Note that, in FIG. 17, the arithmetic processing device 100A does not include the AND circuit AND4 (FIG. 10) for suppressing the reading of the data RDT(B) [127:64] from the high-order bit [127:64] of the FPR 64B. Accordingly, the arithmetic processing device 100A reads data not only from the low-order bit [63:0] of the FPR 64B but also from the high-order bit [127:64] in synchronization with the clock CLK. Therefore, the circuit of FIG. 17 has a problem that the power consumption increases as compared with the circuit of FIG. 10.

From the detailed descriptions above, characteristics and advantages of the embodiments will become apparent. This intends that claims cover the characteristics and advantages of the embodiments described above without departing from the spirit and the scope of the claims. Furthermore, any person having ordinary knowledge in the technical field is to be able to easily come up with various improvements and modifications. Therefore, there is no intention to limit the scope of the inventive embodiments to those described above, and the scope of the inventive embodiments may rely on appropriate improvements and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing device comprising:
an arithmetic circuit capable of operating as a plurality of sub arithmetic circuits according to a bit width of data to be calculated;
a plurality of registers each of which includes a plurality of subregions that corresponds to the plurality of sub arithmetic circuits, respectively;
a mask circuit that masks, when an operation that uses a part of the plurality of sub arithmetic circuits is executed, storage of invalid operation result data output from the sub arithmetic circuit that does not receive data to be subject to the operation in the subregion; and
a data replacement circuit that replaces data, output from the subregion in which the storage is masked, with a zero-value to output the zero-value to the arithmetic circuit when the operation that uses the data retained in the register that includes the subregion in which the storage is masked.

2. The arithmetic processing device according to claim 1, wherein
each of the plurality of subregions of the registers operates in synchronization with a clock, and
the mask circuit stops a supply of the clock to the subregion in which the storage of the operation result data is masked.

3. The arithmetic processing device according to claim 2, further comprising:
a clock stop circuit that stops the supply of the clock to the subregion that retains the data to be replaced with the zero value by the data replacement circuit.

4. The arithmetic processing device according to claim 1, further comprising:
a decoder that decodes an instruction and outputs an instruction code of the decoded instruction, a logical register number included in the decoded instruction, a physical register number that indicates the register to be used in association with the logical register number, and a bit width of data to be used to execute the instruction; and
a renaming table that retains the physical register number and the bit width in association with the logical register number, wherein
the mask circuit determines whether or not to mask the storage of the operation result data in each of the subregions on a basis of the bit width output from the decoder together with the physical register number, and
the data replacement circuit determines whether or not to replace the data output from each of the subregions with the zero value on a basis of the bit width read from the renaming table together with the physical register number.

5. The arithmetic processing device according to claim 4, further comprising:
a reservation station that retains the instruction code, the physical register number, and the bit width output from the decoder and the physical register number and the bit width read from the renaming table based on the logical register number output from the decoder, and outputs information that corresponds to an executable instruction to the arithmetic circuit, wherein
the mask circuit and the data replacement circuit operate on a basis of the bit width output from the reservation station.

6. The arithmetic processing device according to claim 4, wherein
in a case where the decoder has decoded a division load instruction that divides data read from a memory and stores the data into two or more of the registers, the decoder stores the bit width of the data to be divided in areas of the renaming table each corresponding to each of the two or more registers, and outputs a first instruction that loads the data read from the memory to a first register of the two or more registers and a second instruction that transfers a high-order bit side of the data loaded to the first register to a low-order bit side of a second register of the two or more registers,
the mask of the data to be stored in the subregion by the mask circuit is released when the data from the memory is loaded to the first register according to the first instruction, and
the replacement with the zero value by the data replacement circuit is suppressed when the data is transferred from the high-order bit side of the first register to the low-order bit side of the second register according to the second instruction.

7. An arithmetic processing method performed by a computer, wherein the computer including:
an arithmetic circuit capable of operating as a plurality of sub arithmetic circuits according to a bit width of data to be calculated; and
a plurality of registers each of which includes a plurality of subregions that corresponds to the plurality of sub arithmetic circuits, respectively;
wherein the method comprising:
masking, when an operation that uses a part of the plurality of sub arithmetic circuits is executed, storage of invalid operation result data output from the sub arithmetic circuit that does not receive data to be subject to the operation in the subregion; and
replacing data, output from the subregion in which the storage is masked, with a zero-value to output the zero-value to the arithmetic circuit when the operation that uses the data retained in the register that includes the subregion in which the storage is masked.
